(19) United States
(12) Patent Application Publication
(10) Pub. No.: US 2009/0216875 A1
(43) Pub. Date: Aug. 27, 2009

(54) FILTERING SECURE NETWORK MESSAGES WITHOUT CRYPTOGRAPHIC PROCESSES METHOD

(75) Inventor: FLEMING SHI, CUPERTINO, CA (US)

Correspondence Address: PATENTRY, P.O. BOX 151616, SAN RAFAEL, CA, 94915-1616, US

(73) Assignee: BARRACUDA INC., CAMPBELL, CA (US)

(21) Appl. No.: 12/037,746

(22) Filed: Feb. 26, 2008

(51) Int. Cl. G06F 15/173

(52) U.S. Cl. 709/224

(57) ABSTRACT

A network filtering system and method without requiring cryptographic processing of secure message transmissions. The method provides for determining target node ID associations corresponding to domain names of filtered node DNS requests and corresponding network address and address duration data determined according to a corresponding DNS responses. The method also provides for comparing a destination address of a current message transmission corresponding to a filtered node with the determined target node ID associations, and conducting filtering processing of the current message transmission.

### FIELD OF INVENTION

The present invention relates in general to the field of networking and more specifically to network filtering systems and methods.

### BACKGROUND

Conventional network filters provide hardware/software devices for filtering message transmissions to and from one or more associated network users/user-devices (“filtered nodes”) to which network filtering is provided. Operating in a filtered node independent manner and as stand-alone or intermediary network node components, network filters perform filtering according to the payloads of message transmissions between filtered nodes and their respective target nodes that each network filter may monitor.

Conventional network filter operation may be more easily understood by way of contrast with so-called node resident “blockers” or “browser filters”. Blockers are typically integrated with or added to a Web browser that operates on a particular host user device, and provide simple blocking of Internet Web sites with which the host device user may attempt to interact or “browse” (e.g., enabling a parent to block child access to an adult Web site). Typically, when the user enters a universal resource locator (“URL”) or selects a hyperlink, the Web browser provides the URL and applicable addressing data to the blocker. The blocker then compares the entered URL with a previously selected “blocked URL list” and, if included in the list, “blocks” user access to the URL.

Unlike blockers, network filters are typically implemented as or in conjunction with routers, gateways or other intermediary network nodes that operate independently of a Web browser, email program and/or other network access client that may be hosted by a filtered node. Network filters may also filter many filtered nodes and/or different transmission types/aspects.

Until recently, network filters provided filtering of only unsecured hypertext transfer protocol (“HTTP”) message transmissions. Being independently operable and not sharing user-entered or client/device supplied information, network filters operated by monitoring, capturing and analyzing each datablock or “payload” of each HTTP message for each associated filtered node and target node pair. The network filters then applied filtering parameters to filter or allow the unsecured message transmission according to the message payload analysis results.

Recently, network filters have also begun to further apply essentially the same unsecured filtering technique to filtering secured network message trans-missions transmitted using secured hypertext transfer protocol (“SHTTP” or “HTTPS”). As with unsecured messages, the network filter again monitors and captures the SHTTP message transmissions of filtered nodes. However, because SHTTP encrypts transmission payloads, the network filter must decrypt the message transmission payloads of all message transmissions between a filtered node and a target node pair before conducting corresponding message payload analyses. The network filters then again applies filtering parameters to filter or allow the secured message transmissions according to their message payload analysis results, but must also re-encrypt or recall the allowed message payloads before re-transmitting the messages.

Unfortunately, applying un-secured network filtering techniques to secured message transmissions imposes overhead, security and other disadvantages. For example, processing resources must be provided for cryptographic processing of each message payload of all associated message transmissions. While this line of approach may decrease resource requirements by receiving unencrypted payload data or payload filtering information more directly from the filtered node, it introduces new objectionable attributes: providing the network filter with even data sharing or more direct access to unencrypted message transmission data may compromise endpoint-to-endpoint security otherwise provided by secured transfers. Such implementations may also cause transmission delay or expose a network filter manufacturer to at least suspicion if not actual liability where tampering, re-directing, spoofing or other security breach issues may be raised, among still further problems. The present application does not endorse cryptographic processing of secure messages.

Accordingly, there remains a need for network filtering systems and methods that provide for secured transmission filtering to be conducted while enabling problems of conventional network filters to be avoided, specifically, accessing the cleartext of secure messages.

### SUMMARY OF THE INVENTION

Embodiments of the present invention provide systems and methods for conducting multiple node or filtered-node independent filtering (“network filtering”) of secured network transmissions while enabling resource, security and/or other problems of conventional network filters to be avoided. Various embodiments provide for filtering secured network transmissions without requiring cryptographic processing. Embodiments provide for avoiding any cryptographic or other payload processing, or for only selectively conducting cryptographic or other payload processing. Embodiments also provide for conducting unsecured network filtering using the same, different or combined mechanisms/protocols as those used for secured network filtering, for example, by conducting initial or selective additional filtering processing in such cases. Embodiments also provide for conducting network filtering of secured or further message transmissions in conjunction with various network configurations, including but not limited to intra-filtered network or extra-filtered network filtering, that may utilize only not encrypted transmission data of filtered node, filterable node or other node transmissions, among other aspects.

Network filtering according to one embodiment of the invention provides for monitoring message transmissions corresponding to associated filtered, or further, filterable or other network nodes, the transmissions including at least one secured message transmission and at least one protocol interaction corresponding to the filtered node. Network filtering in such embodiment may be conducted on the secured network transmission according to message non-payload, or further, non-message information, and applicable nodes may include intra-network or extra-network filtered or other nodes.

In conjunction with one or more networks employing SHTTP and TCP/IP protocols, for example, the transmissions may include one secured message transmission to which filtering may be applied, and one name service interaction such as a dynamic name service (“DNS”) or reverse dynamic name service (“rDNS”) request and response. The name service request may further be initiated by the filtered node or by the associated network filter.

The embodiment also provides for determining node identification associations corresponding to filtered nodes. The node identification associations (“ID associations”) are determined by (1) analyzing the name service responses to determine target node address (e.g., IP address) and address duration (e.g., “TTL”) data corresponding to the destination names of the respective name service requests, (2) associating that data with the respective target node domain names and (3) storing the resulting ID associations or indicators corresponding thereto.

Other embodiments also provide for further associating the resulting ID associations with all or respective filtered nodes or some portion thereof, while still further embodiments also provide for associating the ID associations with filtered node portions of respective filtered nodes, transmission conditions or other information that may also be stored.

Advantageously, decryption-avoiding network filtering systems and methods according to embodiments of the invention enable network filtering to be conducted in conjunction with local and/or remote secured transmission or via various network configurations to be conducted in a more optimal manner. For example, embodiments enable resource requirements to be generally or selectively reduced, compromising of end-to-end security to be avoided and network filtering to be conducted according to various static or dynamic criteria, node characteristics or selection criteria, among other advantages.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF FIGURES

FIG. 1a is a flow diagram illustrating a network filtering enabled network system (“network filtering system”) according to an embodiment of the invention;

FIG. 1b is a flow diagram illustrating a further network filtering system providing for network filtering of extra-filtered network or other nodes according to an embodiment of the invention;

FIG. 1c is a flow diagram illustrating network filtering of protocol and message transmissions in conjunction with the network filtering system of FIG. 1b, according to an embodiment of the invention;

FIG. 2 is a flow diagram illustrating an exemplary computing system that may comprise one or more network filtering system components or portions thereof, according to an embodiment of the invention;

FIG. 3a is a flow diagram illustrating a network filter according to an embodiment of the invention;

FIG. 3b is a flow diagram illustrating ID association of FIG. 3a in greater detail, according to an embodiment of the invention;

FIG. 4a is a flowchart illustrating a network filtering method according to an embodiment of the invention;

FIG. 4b1 is a flowchart illustrating a method for conducting the determining of one or more target ID associations from not encrypted transmission data of FIG. 4a, according to an embodiment of the invention;

FIG. 4b2 is a flowchart illustrating further details of determining a target node address and duration of FIG. 4b1, according to an embodiment of the invention;

FIG. 4b3 is a flowchart illustrating further ID association maintenance details of FIG. 4b1, according to an embodiment of the invention;

FIG. 4c is a flowchart illustrating a method for conducting the message filtering of FIG. 4a according to an embodiment of the invention;

FIG. 4d is a flowchart illustrating a method for conducting the message filtering of FIG. 4a utilizing exemplary filtering processing policies, according to an embodiment of the invention;

FIG. 5a is a flowchart illustrating a further network filtering method that is applicable to extra-network or other filtered, filterable or other nodes, according to an embodiment of the invention;

FIG. 5b is a flowchart illustrating a method for conducting the name resolution processing of FIG. 5a, according to an embodiment of the invention;

FIG. 5c is a flowchart illustrating a subsequent filtering processing method according to an embodiment of the invention; and

FIG. 5d is a flowchart illustrating selective cryptographic processing of a subset of messages according to an embodiment of the invention.

### DETAILED DISCLOSURE OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention may be practiced without one or more of the specific details, or with other apparatus, systems, assemblies, methods, components, materials, parts, or the like or some combination. In other instances, well-known structures, materials or operations are not specifically shown or described in detail to avoid obscuring aspects of embodiments of the present invention.

Various network filtering embodiments according to the invention may avoid message payload processing by instead exploiting this inventor's observation that other information, while independently provided for unrelated purposes and while often unavailable on a message-by-message basis of conventional filtering, may nevertheless be tracked, captured/received and analyzed (“monitored”) and otherwise utilized in conjunction with network filtering. Also exploited is this inventor's observation that portions of such information are typically not encrypted in conjunction with even secured messaging, and such portions may be monitored and otherwise utilized without requiring cryptographic processing.

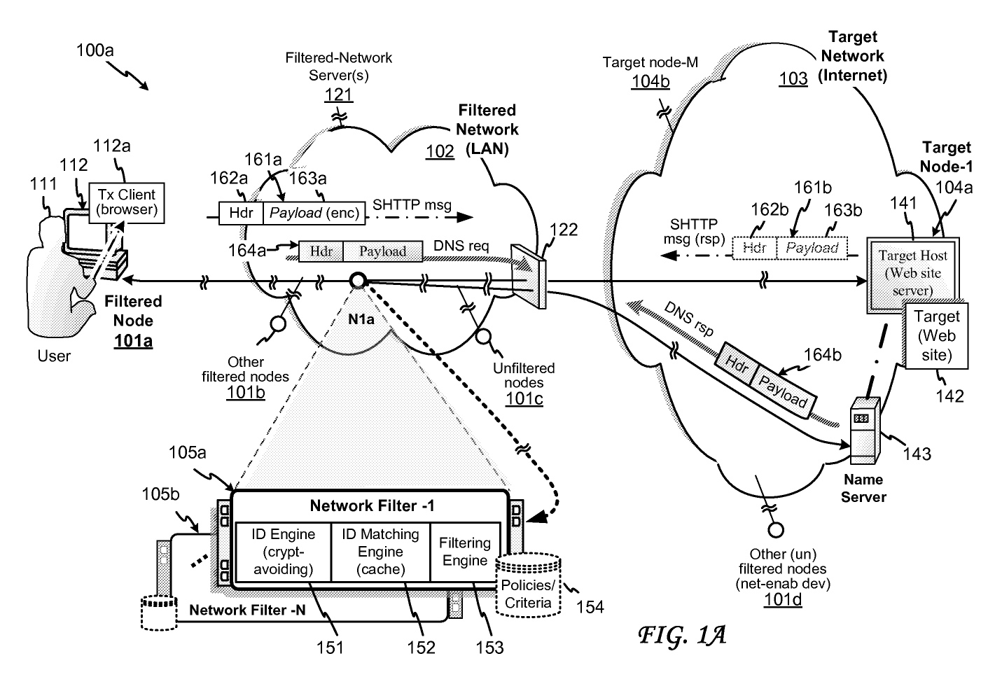

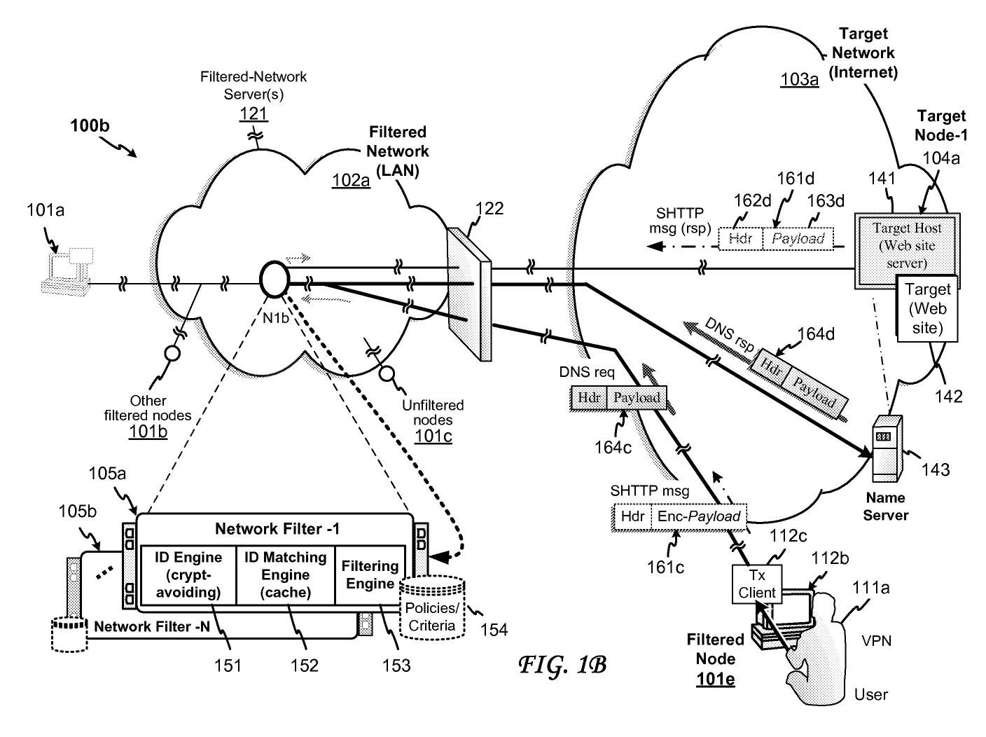

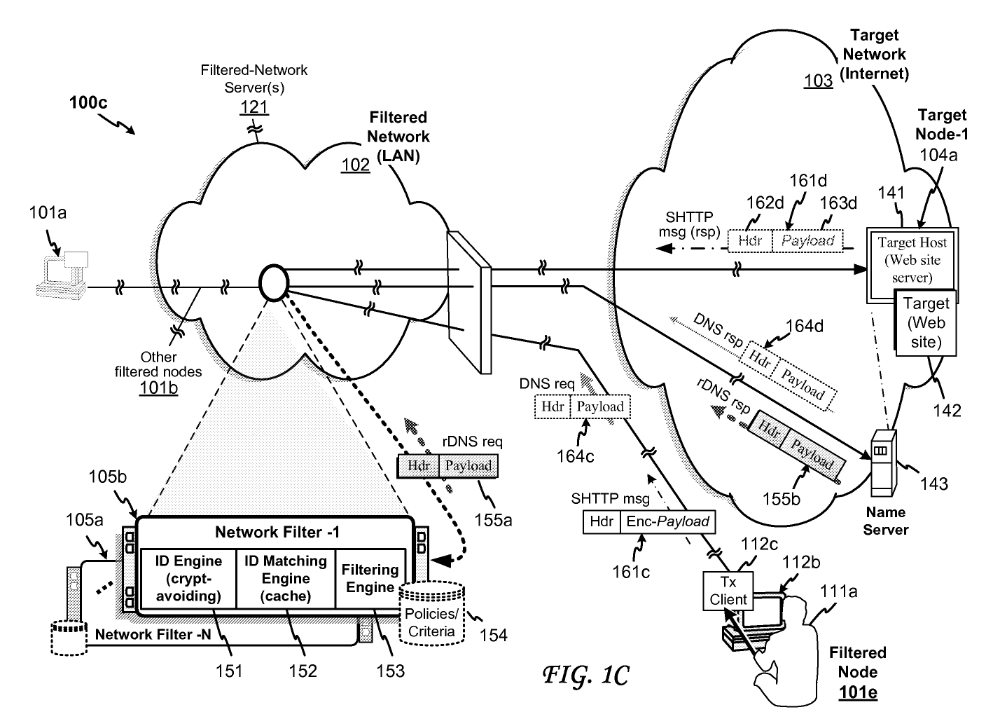

FIG. 1, for example, illustrates a network filtering system embodiment in which one or more of network filters 105a, 105b exploits a name service protocol characteristic of a secured hypertext transfer protocol (“SHTTP” or “HTTPS”) utilized by network 101, 102. Such protocol will be generally referred to hereinafter as SHTTP.

As shown in FIG. 1, name service protocol interaction that is conventionally used by an endpoint device for securing resource address information may also be monitored and otherwise used by a network filter that operates substantially independently of the endpoint node. Despite a different conventional purpose, monitored name service protocol interaction data may further be used in conjunction with network filtering, or further, as filtering criteria according to which network filtering of one or more filtered nodes may be conducted by a network filter. Such criteria may, in one embodiment, correspond with different filtered nodes or even unfiltered nodes, and may be accumulated by a same network filter for use in filtering one or more filtered or filterable nodes, users, transmission clients, users and so on, or combinations thereof, thereby enabling decreased filtering latency or other advantages. In another embodiment, such monitored transmission information of different filtered or other nodes may be separately monitored and used in conjunction with filtering only corresponding user devices, or further, individual users, browser, email or other transmission clients, and so on or some combination of these, thereby enabling system complexity and resource requirements to be reduced, among other advantages.

More specific embodiments of the invention provide for exploiting a characteristic of a dynamic name service (“DNS”) protocol used by endpoint nodes in conjunction with HTTP and SHTTP in that a name service transmission header and payload data of both a DNS request and a DNS response is not encrypted, thereby enabling further monitoring and use of such information by an intermediary node without requiring cryptographic processing. Network filtering embodiments may therefore monitor such name service transmissions to establish and resolve therefrom target node addressing, time-to-live or other data, compare such data with filtered node messages, and otherwise conduct network filtering according to such comparison. Embodiments also provide for storing and maintaining such selected address resolution or other information such that subsequent message data may be compared with the information and filtered, as needed, according to current such information, among other aspects. Network filtering embodiments may further conduct such network filtering operations without requiring cryptographic processing.

Network filtering system embodiments may also similarly utilize other non-message or non-protocol information in conjunction with network filtering. Such information may, for example, include but is not limited to resource reporting information, network/device configuration or re-configuration information, user logon or other information, user device portion identification or other information, pushed, pulled, otherwise monitored, mobile information, determinable time/event conditions, and so on, or some combination.

For clarity sake, the following will provide a more consistent discussion of network filtering embodiments in which HTTP, SHTTP and a dynamic name service (“DNS”) protocol are employed, so that the invention may be better understood. TCP/IP will also be presumed as a widely understood network communications protocol standard, particularly in conjunction with Internet-based communication, resource access or other remote information utilization. Those skilled in the art will appreciate, however, that other standardized or proprietary protocols, other available data, and so on or some combination may also be similarly used. For example, similar operation may also be achieved in conjunction with non-HTTP/HTTPS based protocols, other remote/locally buffered, hierarchical or other name service implementations, non-TCP/IP communication or even other information, in accordance with the requirements of a particular implementation. (Such other information may, for example, include but is not limited to multi-node accumulated name service data, resource/service identification, system/component knowledge tracking, intelligent agent data, data sharing, and so on, or some combination thereof.)

Note that the term “or” as used herein is intended to include “and/or” unless otherwise indicated or unless the context clearly dictates otherwise. The term “portion” as used herein is further intended to include “in whole or contiguous or non-contiguous part” which part may include zero or more portion members, unless otherwise indicated or unless the context clearly dictates otherwise. The terms “multiple” or “multi” as used herein are intended to include “two or more” unless otherwise indicated or the context clearly indicates otherwise. The term “multimedia” is intended to include one or more media types, streams, portions, and so on, or some combination thereof unless the context clearly indicates otherwise. The term “information” is further intended to include data, executable code or both unless otherwise indicated or the context clearly indicates otherwise.

Referring now to FIG. 1a, there is seen a flow diagram illustrating a network filtering enabled network system 100a (“network filtering system”) according to an embodiment of the invention. System 100a broadly provides networks 101, 102 through which one or more node-independent or multiple-node filters (“network filters”) 105, 105a may provide filtering processing (“network filtering”) of at least secured message transmissions (“messages”) 161a-b between one or more users/user devices to be filtered (“filtered nodes”), e.g., 103, and one or more network resources (“target nodes”), e.g., 121.

Various network filtering embodiments according to the invention provide for conducting such network filtering without requiring cryptographic processing of messages to/from each filtered node. Various embodiments provide for conducting network filtering of secured, or further, unsecured messages, and may utilize the same or different filtering mechanisms (e.g., techniques or devices) for conducting such message filtering. Embodiments may, for example, conduct network filtering as completely devoid of: message payload cryptographic or other processing, all transmission payload cryptographic processing or all cryptographic processing. Embodiments may also provide for selectively employing cryptographic or other message payload processing in conjunction with a subset of messages during initial or, more typically, subsequent filtering of a message or a later subset of messages corresponding to a same or related filtered node or target, and so on, or some combination of these.

Note that the term “resources” is intended to broadly refer to endpoint or other nodes with which a filtered node may communicate for other than mere protocol execution, whether or not a “resource” node actually provides a network resource to the filtered node. The term “message” is further intended to distinguish a resource request or related communication between a filtered node and a target node from mere protocol execution that may be initiated by or otherwise correspond to a filtered node, so that the invention may be better understood. However, neither term should be considered as limiting. It will become apparent, for example, that message transmission between a filtered node and a target node may be directly or indirectly conducted, e.g., via intermediary network nodes of one or more real/virtual network portions. One or more of load balancing, backup, shadowing and so on may further be conducted and transmission related thereto may include non-message or message transmissions. Transmissions associated with network initialization, reconfiguration, address/capability propagation, recovery and so on that may be conducted are also distinguishable from “message” transmissions between a filtered node and a particular target node, among other examples.

As shown in the FIG. 1 example, network filtering system 100a includes one or more filtered nodes and unfiltered nodes 101a-d, which nodes are at least intermittently communicatingly coupleable, via one or more networks (e.g., 102, 103), with one or more target nodes, e.g., 104a-b. Filtered nodes, for purposes of the present example, include first endpoint nodes for which one or more network filters 105a-b currently provides filtering, while target nodes comprise second endpoint nodes including network resources that may but need not be hosted by one or more network servers 141 and may comprise targets of filtered (or unfiltered) node message transmissions. Unfiltered nodes, for purposes of the example, include endpoint nodes that are not currently subject to network filtering by one or more of network filters 105a-b. In one embodiment, filtered nodes are predetermined, e.g., according to IP addresses or other criteria stored by a network filter, while in other embodiments, unfiltered nodes may be dynamically determined as filtered nodes, e.g., as discussed below. Filtered and unfiltered nodes to which network filtering may be provided (but need not be currently provided) are referred to herein as “filterable” nodes. Filtered, filterable, unfiltered, target or other nodes may be coupled in a wired or wireless manner in accordance with the requirements of a particular implementation.

Filtered, or further unfiltered nodes 101a-d, are also at least intermittently communicatingly coupleable with one or more name servers, e.g., 143, or other mechanisms providing name services or similar functionality. Since a wide variety of well known or other name service mechanisms may be used in accordance with the requirements of a particular implementation, for clarity sake, name servers and support or other mechanisms providing name service aspects are also referred to separately and collectively herein as “name servers” or “name services”.)

Filtered node 101a and other filtered/unfiltered nodes 101b-d may each include substantially any single or multi-function wired or wireless device or coordinated devices with which a user may conduct message transmission via applicable networks (here, via networks 102, 103). Filtered or filterable ones of nodes 101a-d may, for example, include conventional or other user devices for conducting such transmission, and which user device or devices may also be utilized for a wide variety of other purposes that may be related or unrelated to such transmission. User devices may, for example, include but are not limited to network enabled devices such as fixed/mobile personal computers (“PCs”), land, cellular, satellite, network or other so-called smart phones, so called personal data assistants (“PDAs”), game consoles, settop boxes, media centers, smart appliances, GPSs, origami, laptop or other portable computing devices, and so on, or some combination thereof.

Within filtered node 101a, one or more hardware/software clients (e.g., 112a) provide for responding, in a conventional manner, to user input by conducting corresponding message transmission, and for implementing higher level communication protocols. Web browsers, for example, are well known transmission mechanisms that are operable for accessing resources on the World Wide Web portion of the internetwork commonly referred to as the Internet, as well as with a user device or home, local, other or combined network or other resources. Conventional Web browsers also commonly provide configurable and extensible mechanisms for implementing HTTP, SHTTP, dynamic name service (“DNS”) interaction, other name service or other transmission/communication protocols, and so on, and may include corresponding resident or add-on protocol or other processing components. Suitable conventional Web browsers may include but are not limited to Mozilla Firefox, Apple Computer Safari, Microsoft Corporation Internet Explorer, and so on.

Web browser 112a may, in the present Internet based network embodiment, operate in a conventional manner for receiving and responding to user entry, hyperlink selection or other indication of a target Web name (e.g., site or page, also referred to as a “domain name”). The Web browser broadly responds to domain name selection by determining a Web address corresponding to the Web name. If such a Web address is not yet known to the Web browser or has expired, then the Web browser initiates a DNS request 161a; if available, a DNS request receiving name server 143 provides a DNS response 161b including one or more Web addresses, an address viability time limit or “time-to-live” and any further corresponding data. Having determined a Web address, the Web browser initiates message transmission to a Web address. (It will be appreciated that, when implemented in software, portions of a base application, add-on or other software may include local, remote or mobally executable code. Those skilled in the art will also appreciate that email, other transmission clients or other transmission mechanisms may also be utilized in conjunction with network filtering, and in a similar manner as with Web browsers. It will also be appreciated that various DNS and other name service protocol interactions are well known. For clarity sake, such operation will not be repeated herein.)

System 100a also comprises a composite network including network 102 and network 103. In addition to providing a communications network through which the aforementioned filtered, unfiltered and target node message and other transmission may be conducted, network 102 also provides a communications network through which one or more of network filters 105a-b may be coupled for monitoring/filtering such transmission, while network 103 provides a network to which one or more target nodes may be more directly coupled. Therefore, network 102 and network 103 are also referred to herein as a “filtered network” and a “target network” respectively.

Each of networks 102, 103, further networks or one or more portions thereof may more generally include a private, public or other fixed or reconfigurable real or virtual network, and may comprise a local area network or wide area network (“LAN” or “WAN”), and so on. For consistency sake, however, the following examples will presume a two network configuration in which filtered network 102 comprises a business entity or home LAN, and target network 103 comprises the Internet, so that aspects of the invention may be better understood.

Filtered network 102 may be physically or virtually configurable such that transmission of filtered nodes, or further potential filtered nodes is at least propagated or otherwise routed through a node to which at least one of network filters 105a-b is coupled and through which the network filter or filters may therefore monitor such transmission. Network reconfiguration that may be conducted, e.g., due to failure of a network device, providing for special operation, and so on, may also be conducted in an otherwise conventional manner such that transmission monitoring by one or more corresponding network filters may be conducted. Other “monitoring” alternatives that may be used, including but not limited to configuring network 102 or network 103 to independently transfer, to a network filter, transmissions respecting each associated filtered node, are found to add undesirable complexity and are less preferred. (For clarity sake, network configuration and re-configuration will also be referred to as “configuration”, unless otherwise specifically stated or the context clearly indicates otherwise.)

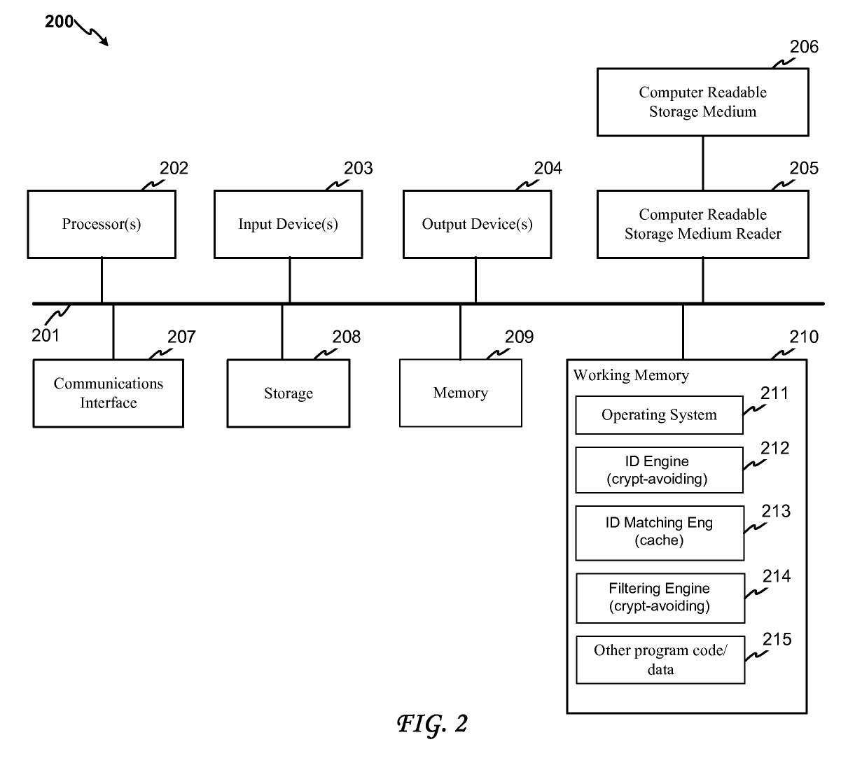

Within network 102, each of network filters 105a-b provides for determining filterable nodes to be filtered (also referred to herein as “associated” or “corresponding” filtered nodes). Network filters 105a-b also provide for monitoring transmission data of transmission that is initiated or otherwise conducted by such nodes, and for filtering corresponding message transmissions according to at least transmission data—without requiring cryptographic processing of at least message transmissions. Each of network filters 105a-b may be implemented as or coupled with an otherwise conventionally operable router, gateway, and so on or component thereof, and may generally include otherwise conventional or other hardware or software portions for conducting such network component operation (e.g., see FIG. 2).

Each of network filters 1 through N 151a-b includes a cryptography avoiding identification engine, an identification matching engine and a filtering engine, which engines are exemplified by engines 151-153 respectively of network filter 105a. Identification engine 151 provides for determining associated filtered nodes (e.g., see below) and for monitoring transmission data of at least associated filtered nodes, or further, other filterable or otherwise monitor-able nodes. Identification engine 151 also provides for identifying applicable ones of source and target nodes, and for transferring monitored data to identification matching engine 152.

Identification matching engine (“matching engine”) 152 provides for receiving monitored data from engine 151, and for paring, storing, discarding or otherwise maintaining such data. Matching engine 152 also provides for identifying filtering instances in which filtering is to be conducted, and in such instances, for correspondingly initiating message transmission filtering of current or corresponding messages by filtering engine 153. In various embodiments, such identifying includes engine 152 determining that a correspondence exists between a monitored message transmission and at least one of a filtered node and a target node, or more typically, a filtered node and target node pair. Filtering engine 153 further provides for responding to matching engine 152 by determining whether filtering should be conducted, and if so, for conducting such filtering.

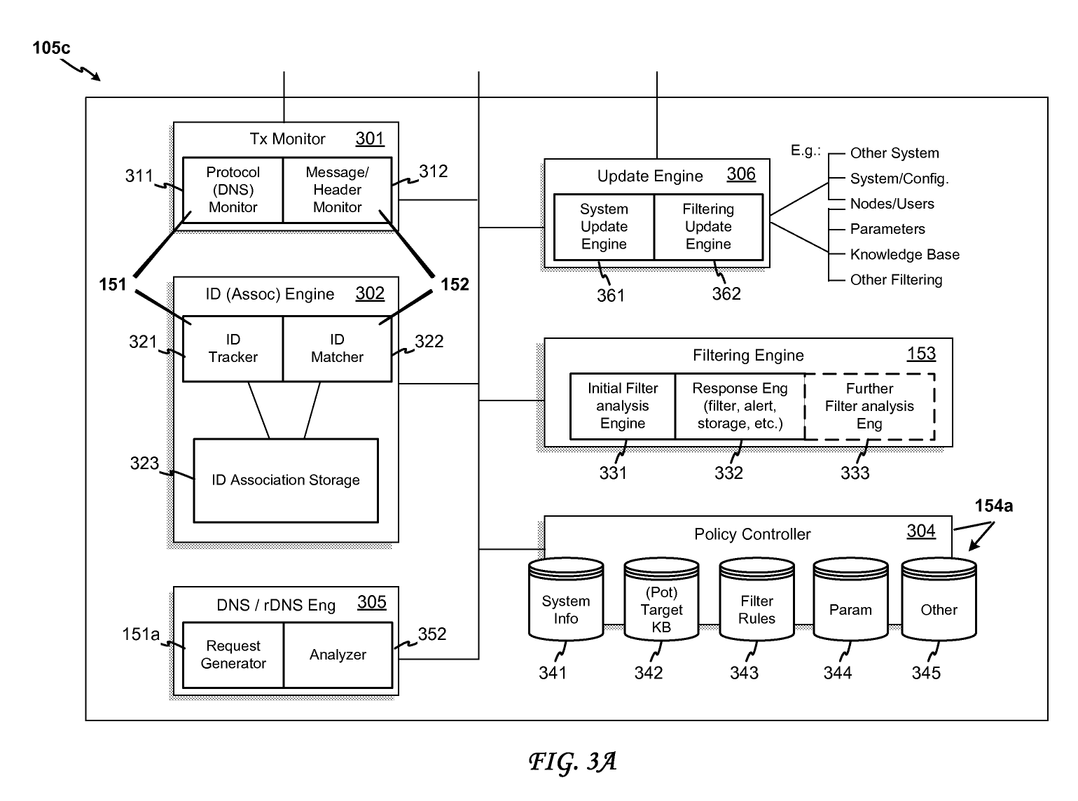

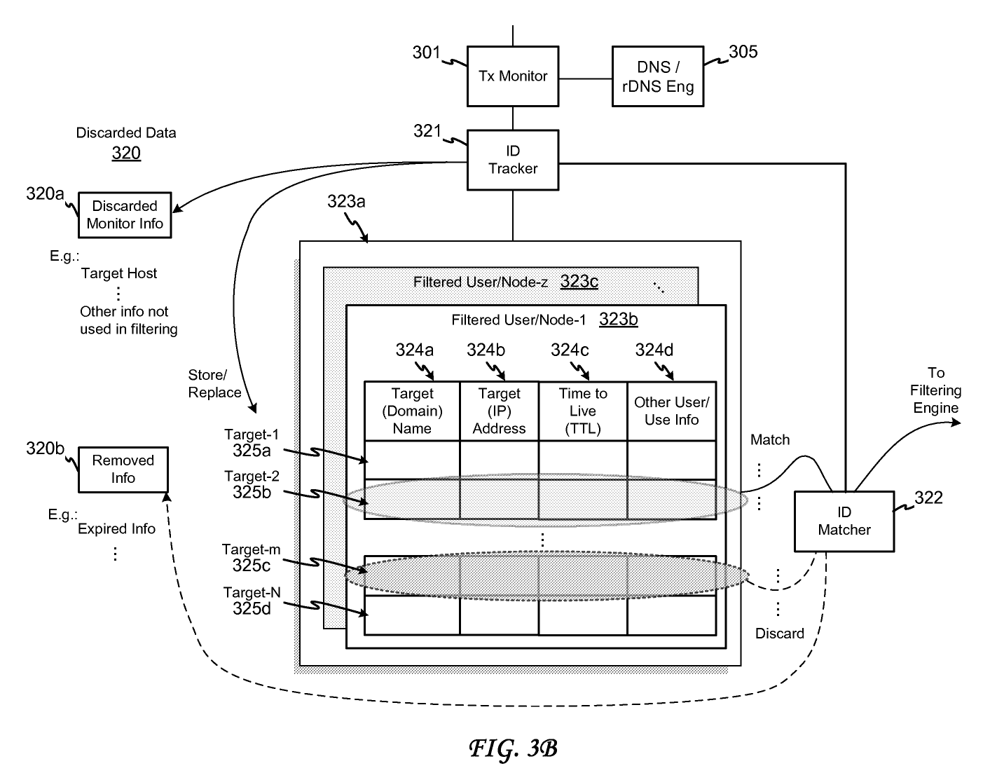

In various embodiments, one or more of network filters 105a-b may be implemented in a configurable manner, whereby a network filter may receive and store static or dynamic filtering processing criteria or policies, e.g., policies 154. A network filter may be configured in a stand-alone manner (separated from network 102) or remotely addressable manner within network 102 and otherwise conventional techniques for configuring other devices may be used Filter configuration criteria (“configuration criteria”) in various embodiments may include filtering criteria (e.g., for determining node associating, monitoring, tracking, filtering, and so on), as well as administration criteria (e.g., protocol, security and implementation criteria, and so on). Note that the terms “criteria” and “policies” are used interchangeably herein to collectively include policies, parameters, criteria, knowledge bases, and so on that may be used to bound or otherwise direct filtering processing. (See also FIG. 3a.)

A further embodiment provides filtering criteria including filter processing indicators (“processing indicators”). The processing indicators indicate whether a message transmission is allowable/disallowable, and if so, one or more corresponding responsive actions. Responsive actions may, for example, include but are not limited to: allowing/preventing message transmission to/from a filtered node, providing a filtered, unknown target or other alert to a user, administrator or other entity, storing event or other data corresponding to a message transmission attempt, selectively initiating subsequent filtering that may include cryptographic processing, and so on or some combination. (As discussed, various embodiments may completely exclude cryptographic or other protocol/message processing, while other embodiments may provide for cryptographic or other protocol/message processing to be selectively provided in conjunction with initial filtering or as a subsequent filtering of a same or subsequent message.)

Of the remaining illustrated network 102, 103 components, filtered network 102 further includes servers 121 and firewall 122, while target network 103 further includes target host 141, target 142, target node 104b and name server 143. Servers 121 may include one or more of Web, email, conference or other servers that may be utilized in a particular network system. Firewall 122 is illustrative of a wide variety of security mechanisms, such as firewalls, encryption, fire zone, compression, secure connections, and so on, one or more of which may be used in conjunction with various system 100a-c components. Many such server and security mechanisms are well known in the computer and networking arts and may be utilized in accordance with the requirements of a particular implementation. Such components may be used in an otherwise conventional manner.

Target host 141 and target 142 illustrate an exemplary first target node 140a, while target node-M 104b exemplifies one or more further target nodes that may be implemented in a same or different manner. Target host 141 may, for example, include a network server (e.g., Web server) or other suitable conventional or other hosting mechanism for hosting one or more resources (e.g., Web sites) of one or more vendors or other resource providers that may be accessible to one or more filterable or other system 100a nodes. Target 142a further illustrates one or more particular resources, e.g., Web sites or Web pages, that may be provided in a more direct or hosted manner, e.g., by target host 141. (A wide variety of hosted and non-hosted or other more directly accessible resource implementations are, for example, well known in the art.)

FIGS. 1a-c further illustrate some of many examples of how network filtering according to embodiments of the invention may be utilized in conjunction with different network/node implementations, protocols or time/event conditions. Various demarcations are provided to facilitate such illustration. Thin solid lines indicate wired or wireless couplings of the various components through which singly or multiply directed transmissions may be conducted. Wide solid lines indicate an example of protocol transmission, here name service interaction, that may be conducted, while dot-dash patterned lines indicate an example of message transmission that may be conducted in a paired manner and that are filterable by a corresponding network filter. (It will be appreciated that broadcast, multicast, or other so called one-to-many or many-to-one transmission may also be conducted or similarly filtered). Wide dashed lines illustrates how message and non-message transmission data may be monitored by one or more network filters that may be coupled more directly or indirectly to a filtered network, e.g., as, integrated with or via a router, gateway or other filtered network node.

FIG. 1a illustrates network filtering of message transmission corresponding to a filtered network node, while FIGS. 1b and 1c illustrate network filtering of message transmission corresponding to a filterable node that is coupled via a virtual private network (“VPN”) or other extra-filtered network coupling operating via multiple networks (here, filtered network 102 and target network 103).

Operationally, network filter 105a of FIG. 1a monitors network transmissions of filtered network transmission mechanisms (e.g., Web browser 112a) via coupling node N1a. Because user 111 enters a Web name corresponding to target 142 for which a Web address is unknown to browser 112a, Web browser 112a initiates DNS request 164a. Engine 151 of network filter 105a determines, according to the source address of the not encrypted transmission 164a header and the name service request and Domain name of the not encrypted transmission 164a payload, node 101a has initiated a DNS request (and may determine that a corresponding DNS response is expected). Engine 151 of network filter 105a further monitors DNS response 164b and determines, e.g., from the requester address and Domain or “Web” address of the not encrypted DNS response payload, that the DNS response corresponds to node 101a, and further, the Web address and TTL of the Web address corresponding to the Web name of the node 101a DNS request. Matching engine 152 stores the Web name and Web address pair, as well as the TTL, indicating an association of the Web name, Web address and TTL triplet. (Engine 152 may also indicate an association of the triplet with at least filtered node 101a (e.g., as was already discussed). Network filter 105a may process other DNS requests and responses corresponding to node 101a or other filtered nodes in a similar manner, and may expect one or more message transmissions corresponding to the DNS protocol interaction or interactions.

Web browser 112a, in conjunction with receiving the Web address, initiates HTTPS message 161a to the Web address of the received DNS response. Identification engine 151 determines, according to the source address of the not encrypted message transmission 164a header, that the message transmission is transmitted by filtered node 101a, and determines, according to the destination address of the message transmission 164a header, that the transmission is a message transmission directed to target 142. Engine 151 transfers the determined source and destination (or “target”) address pair to matching engine 152, which engine 152 compares to stored source and destination address pairs (or further, to a source address, target address and TTL triplet or still further data, e.g., as shown in FIG. 3b.). Engine 152 determines, from a correspondence with the stored pair (or triplet or other data), that the transmission is subject to filtering and initiates filtering engine 153. Filtering engine 153 conducts filtering processing corresponding to the received information, including conducting one or more corresponding filtering responses. Thus, assuming that a corresponding filtering response filters such transmission, network filter 105a prevents applicable further transmission of message transmission 161a (in embodiments that holds re-transmission during filtering processing) and message transmission 161b (which may be similarly processed according the source and destination addresses of the corresponding not encrypted message transmission header 162b).

FIG. 1b illustrates a further network filtering enabled network system example 100b in which a filterable node 101e comprises an extra-filtered network node that establishes a virtual private network (“VPN”), the transmissions of which are propagated or otherwise routed to and filtered by a network filter 105a of a filtered network 102a. The filterable node may again vary widely and may, for example, include a wired or wireless vendor/customer workstation coupled through a vendor/customer LAN, a personal information manager (“PIM”), origami device, net-enabled phone or other mobile device coupled through a LAN, WiFi, cellular or satellite service, and so on. The filterable node may also be coupled more directly, via an Internet service provider (“ISP”) and so on, in accordance with the requirements of a particular implementation. Network filtering in conjunction with system 100b may nevertheless operate in conjunction with node 101e or other filterable nodes in much the same manner as with system 100a of FIG. 1a.

As with system 100a, network filter 105a monitors network transmissions of filtered network transmission mechanisms (e.g., Web browser or email client 112c) via coupling node N1b. Presuming again that a user 111a enters a Web name corresponding to target 142 for which a Web address is unknown to email client 112c, client 112c initiates DNS request 164c. Engine 151 of network filter 105a determines, according to the source address of the not encrypted transmission 164c header and the name service request and Web name of the not encrypted transmission 164c payload, that node 101e has initiated a DNS request. Engine 151 further monitors DNS response 164d and determines, e.g., from the requester address and Web address of the not encrypted DNS response payload, that the DNS response corresponds to node 101e, and further, the Web address and TTL of the Web address correspond to the Web name of the node 101e DNS request. Matching engine 152 stores the Web name and Web address pair, as well as the TTL, indicating an association of the Web name, Web address and TTL triplet, and may provide for further association with node 101e, other nodes, and so on, e.g., as was already discussed respecting FIG. 1a. Network filter 105a may process other DNS requests and responses corresponding to node 101e or other filterable nodes in a similar manner, and may expect one or more message transmissions corresponding to the DNS protocol interaction.

Client 112c, e.g., an email or Web client, in conjunction with receiving the Web address, initiates SHTTP message 161c to the received Web address. Identification engine 151 determines, according to the source address of the not encrypted message transmission 164a header, that the message transmission is transmitted by filtered node 101a, and determines, according to the destination address of the message transmission 164a header, that the transmission is a message transmission directed to target node 142. Engine 151 transfers the determined source and destination (or “target”) address pair to matching engine 152, which engine 152 compares to stored source and destination address pairs (or further, to a source address, target address and TTL triplet, and so on). Engine 152 determines, from a correspondence with the stored pair or triplet (or further data), that the transmission is subject to filtering and initiates filtering engine 153. Filtering engine 153 conducts analysis and filtering (“filtering processing”) corresponding to the received information, including conducting one or more corresponding filtering responses. Thus, assuming that a corresponding filtering response filters such transmission, network filter 105a prevents applicable further transmission of message transmission 161c (in embodiments that hold re-transmission during filtering processing) and message transmission 161d (which may be similarly processed according the source and destination addresses of the corresponding not encrypted message transmission header 162d).

In a more specific embodiments, similar correspondence will also exist with respect to subsequent messages transmitted between the current filtered or other filtered nodes and the target node and, assuming an absence of contradictory network filtering criteria that may cause more individualized filtering processing, similar filtering processing will also be conducted by the network filter in conjunction with monitoring of such subsequent messages.

FIG. 1c illustrates how a data resolving network filtering embodiment provides for network filtering despite an unavailability of target node addressing interaction monitoring or related data.

The network enabled network system 100c of FIG. 1c may be configured in the same manner as with system 100b of FIG. 1b, and may operate in much the same manner as systems 100a, 100b of FIGS. 1a and 1b respectively. Filtered node 101e or other filterable nodes may, for example, conduct name service interaction and message transmission and one or more network filters that may be utilized may generally conduct monitoring, tracking, matching and filtering of such transmissions as with the previous examples.

The present network filtering embodiment, however, also provides for conducting network filtering where a name service request or response of a filtered node (e.g., node 101e) may remain undetected or “un-monitored” by a corresponding network filter (e.g., network filter 105b). A lack of name service interaction or other protocol data may, for example, arise where a network address has previously been acquired, buffered or otherwise become known to a filterable node client, in cases of network propagation failure, an rDNS failure (e.g., see below) or where network filter 105 is otherwise unable to monitor or further process interaction data. Those skilled in the art will appreciate that the unavailability of corresponding name service data may result in a network filter monitoring a network transmission including a target node address for which the network filter lacks a target node name. Since the present embodiment conducts network filtering according to a static target identification (e.g., here a Web name), an un-resolvable lack of such identification or “unknown target name” may prevent filtering processing. The illustrated network filter embodiment 105b, however, provides for responding to an unknown target name in a monitored message transmission by initiating an address-to-name resolution protocol commonly referred to as a reverse DNS. Network filter 105b may also provide for filtering finally or otherwise unresolved target node addressing according to default or other suitable mechanisms (e.g., allowing or disallowing a message transmission for which a target node name remains unknown).

More specifically, network filter 105b may, for example, monitor transmissions of filterable, filtered or other nodes, such as node 100e, as was already discussed. As in the previous examples, user 111a may initiate a message transmission to target node 104a and client 112c may respond initiating a DNS request 164c that includes a corresponding static target identifier (here a Web name), but which request is not processed by network filter 105b. Name server 143 may further respond to request 164c by providing DNS response 164d, which response may also include the Web name but is also or instead not processed by network filter 105b. Client 112c may then initiate a secure or unsecured message transmission, e.g., here SHTTP message 161c, which message includes a target node address but not a target node name and which message is monitored by network filter 105a.

In accordance with the present embodiment, matching engine 152 of network filter 105b determines that the target address of the monitored, unencrypted message header does not correspond with a stored “known” target node name or “corresponds to an unknown target name”. While network filter 105b may otherwise employ initial selective cryptographic processing of the encrypted message payload (e.g., see below), the present network filter 105b is instead configured to initiate a reverse DNS (“rDNS”) request 155a including the known target node address (e.g., according to one or more applicable ones of policies 154). Network filter 105b further receives rDNS response 155b responsive to the corresponding rDNS request 155a from name server 143, and determines the corresponding target name from the unencrypted rDNS response payload. Network filter 105b stores a target identification triplet including the received target name and TTL of the rDNS response (or further data) and conducts filtering processing accordingly, for example, as was already discussed. (It will be appreciated that a network filter embodiment may nevertheless conduct selective cryptographic or other processing, for example, according to one or more policies corresponding to rDNS failure, desirability of additional data, and so on. It will also be appreciated that similar mechanisms may also be employed respecting other protocol-based or other data that may be unavailable to a network filter.)

The FIG. 2 flow diagram illustrates a computing system embodiment that may comprise one or more of the components of FIGS. 1a through 1c or portions thereof. While other alternatives may be utilized or some combination, it will be presumed for clarity sake that components of systems 100a through 100c and elsewhere herein are implemented in hardware, software or some combination by one or more computing systems consistent therewith, unless otherwise indicated or the context clearly indicates otherwise.

Computing system 200 comprises components coupled via one or more communication channels (e.g. bus 201) including one or more general or special purpose processors 202, such as a Pentium®, Centrino®, Power PC®, digital signal processor (“DSP”), and so on. System 200 components also include one or more input devices 203 (such as a mouse, keyboard, microphone, pen, and so on), and one or more output devices 204, such as a suitable display, speakers, actuators, and so on, in accordance with a particular application.

System 200 also includes a computer readable storage media reader 205 coupled to a computer readable storage medium 206, such as a storage/memory device or hard or removable storage/memory media; such devices or media are further indicated separately as storage 208 and memory 209, which may include but are not limited to hard disk variants, floppy/compact disk variants, digital versatile disk (“DVD”) variants, smart cards, partially or fully hardened removable media, read only memory, random access memory, cache memory, and so on or some combination, in accordance with the requirements of a particular implementation. One or more suitable communication interfaces 207 may also be included, such as a modem, DSL, infrared, RF or other suitable transceiver(s), and so on or some combination, for providing inter-device communication directly or via one or more suitable private or public networks or other components that may include but are not limited to those already discussed.

Working memory 210 further includes operating system (“OS”) 211, and may include one or more of the remaining illustrated components in accordance with one or more of a particular device, examples provided herein for illustrative purposes, or the requirements of a particular application. Cryptography avoiding identification engine 212, matching engine 213 and filtering engine 214 may, for example, be operable in substantially the same manner as was already discussed. Working memory of one or more devices may also include other program code or data (“information”) 215, which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on or some combination and may be implemented as a real or virtual OS. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for conducting but not limited to the examples discussed elsewhere herein. Other program code/data 215 may, for example, include one or more of security, compression, synchronization, backup systems, groupware, networking, or browsing, client or other transmission mechanism code, and so on, including but not limited to those discussed elsewhere herein.

When implemented in software, one or more of system 100a through 100c or other components may be communicated transitionally or more persistently from local or remote storage to memory (SRAM, cache memory, and so on or some combination) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device 208 or memory 209) in accordance with the requirements of a particular implementation.

Turning now to FIG. 3a with further reference to FIG. 3b, there is seen a network filter 105c according to an embodiment of the invention. As shown in FIG. 3a, network filter 105c includes communicatingly coupleable components including transmission monitor 301, identification association engine 302, filtering engine 153, policy controller 304, policy storage 341-345, and update engine 306. Portions of network filter 105c that may correspond to discussed components 151 through 154 are also indicated using consistent numbering.

Transmission monitor 301 provides for monitoring portions of transmissions corresponding to filtered or other nodes and transferring monitored data to other network processor 105c components for processing, and for transmitting or otherwise transferring data received from such other components. Transmission monitor 301 includes protocol monitor 311 and message/header monitor 312.

Protocol monitor 311 provides for network filter 105c monitoring of protocol transmissions of filtered or other nodes and for transferring monitored portions to other network filter components. In more specific embodiments, protocol monitor 311 may be implemented in a static or configurable manner for monitoring dynamic name service (“DNS”), reverse DNS (“rDNS”) or other name service protocol interaction corresponding to filtered or other nodes. Message/header monitor 312 provides for network filter 105c monitoring of complete or partial messages or other non-protocol specific transmission portions of filtered or other nodes. In one embodiment, monitor 312 provides for monitoring secured message headers secured according to SHTTP, while in other embodiments, monitor 312 may provide for monitoring other message transmission portions (e.g., payload), unsecured message transmission portions or protocols other than HTTP and SHTTP or the further presumed TCP/IP.

Identification association engine 302 provides for identifying monitored transmission portions monitored by transmission monitor 301 and includes identification tracker 321, identification matcher 322 and identification association storage 323. Identification tracker 321 provides for determining, from monitored message, protocol and other transmission information, applicable ones of transmission source and destination name and address, address duration or other data, for removing unnecessary such data (that is not needed for conducting further network filtering operation) and for storing remaining data, indicators indicating such data or associations thereof (“transmission identification data”) in identification association storage 323. Identification matcher 322 provides for comparing received such data, typically message source/destination data, with transmission identification data stored in identification association storage 323, and for transferring comparison result indicators indicating such comparison, or further, stored transmission identification data portions or further data (e.g., see above), to filtering engine 153 or other network filter 105c components. Identification matcher 322 in one embodiment also provides for determining whether expired or other information (e.g., according to a stored or received time-to-live) should be removed from storage 323, and for correspondingly replacing or otherwise discarding such information.

FIG. 3b illustrates a cache-based embodiment of identification association engine 302 in greater detail. In this embodiment, identification tracker 321 receives monitored data from transmission monitor 301 and determines portions of the monitored data that is to be discarded 320, and for discarding such data portions. Data that may be discarded may, for example, include but is not limited to a host identifier, or additional node names, addresses or other data that may be included in a DNS or rDNS response. (In other embodiments, identification tracker 321, identification matcher 322 or a dedicated cache controller (not shown) may also replace expired data with new monitored data, or otherwise discard expired, already utilized or other data, or data of inactive or removed nodes or node components, among other examples.)

Identification tracker 321 also provides for storing remaining data that is not discarded in identification association storage 323a. As shown, the present ID association storage 323a example includes an ID association cache and provides a separate ID cache for storing data corresponding to each of one or more filtered nodes. Thus, for example, z ID caches 323b through 323c may be created for storing data corresponding to z filtered nodes. Such ID caches may be created in a predetermined manner anticipating a corresponding number of filtered nodes, in conjunction with storing a first corresponding data portion or otherwise in accordance with a particular implementation. (In other embodiments, separate or shared ID caches may also correspond to various filtered node portions, target node characteristics, qualifications, conditions, and so on, for example, as was already discussed.)

Each of ID caches 1 through z of the present example provides a data table for storing, in an associated manner, at least target identification information corresponding to each actual target to which a DNS protocol interaction or message transmission is initiated by the corresponding filtered node. Target identification information for each actual target node 1 through N 325a-d in the present example includes a target node domain name, a target node IP address and a time to live or “TTL”, as exemplified by target information columns 324a through 324c respectively of ID cache 323b. The present example also provides for storing other user or use information indicators, for example, as was already discussed. Each filtered node may be identified according to its IP address, which is associated with each respective ID cache. (It will be appreciated that a wide variety of other mechanisms may also be used, which mechanisms will also be referred to herein as ID caches, tables, lists or storage.)

Returning now to FIG. 3a, filtering engine 153 provides for determining filtering to be applied to message transmissions and, in the present embodiment, is operable according to data or indicators received from identification matcher and filtering rules, parameters or other criteria received from policy controller 304. Within filtering engine 153, initial filter analysis engine (“initial filtering engine”) 331 provides for determining whether filtering may be conducted according to received data/indicators and filtering to be applied, while further analysis engine (“subsequent filtering engine”) 333 provides for determining further filtering analysis to be conducted (e.g., selective cryptographic or other payload processing) and for conducting such filtering, and response engine 332 provides for determining responsive action according to the initial or subsequent filtering. Responsive action may, for example, include complete or partial transmission filtering, providing user, administrative or other alerts, storing/reporting analytics or additional information and so on, e.g., as was already discussed.

Returning again to FIG. 3a, policy engine 154a provides for responding to update engine 306 by storing operational criteria (“policies”) received from update engine 306, and for responding to filtering engine 153 by retrieving and transferring policies to filtering engine 153. Such policy transfer is conducted by policy controller 304, which stores and retrieves the policies from policy storage 341 through 345.

Of the further illustrated network filter 105c components, DNS/rDNS engine 305 is illustrative of protocol generation and analysis components that may be utilized. In this example, network filter 105c provides for name service interaction generation and analysis. More specifically, request generator 151a is initiated by filtering engine 153 in response to the above-discussed unknown target node name-and-address correspondence condition. Such condition may, for example, be determined in conjunction with monitor 312 monitoring a message transmission for which identification association engine 302 cannot establish a corresponding known name and initiates request generator 151a. Generator 151a responds by generating the above-discussed rDNS request, which request is transmitted by monitor 301. Monitor 311 of transmission monitor 301 further responds to a transmission response (i.e., receipt or lack of receipt of a corresponding rDNS response) by transferring the response or response indicator thereof to analyzer 352. Analyzer 352 further transfers an analysis indicator indicating the analysis results to engine 302, which may, for example, determine a correspondence and initiate filtering by filtering engine 153 as was already discussed. Update engine 306 includes system update engine 361 and filtering update engine 362, which respectively provide for receiving or transmitting update information corresponding filter 105c operation (e.g., system information) and filtering (e.g., policies, reporting, remote storage, and so on).

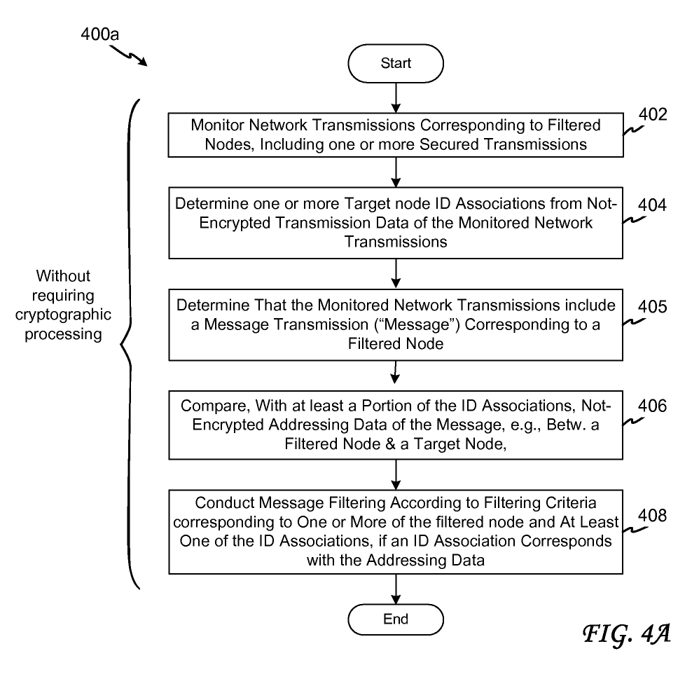

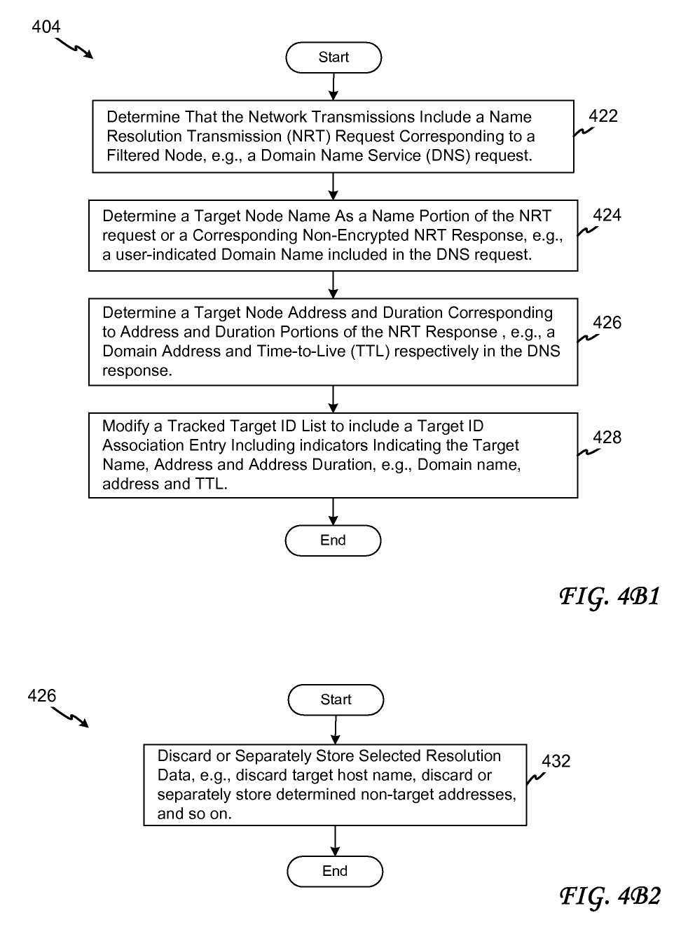

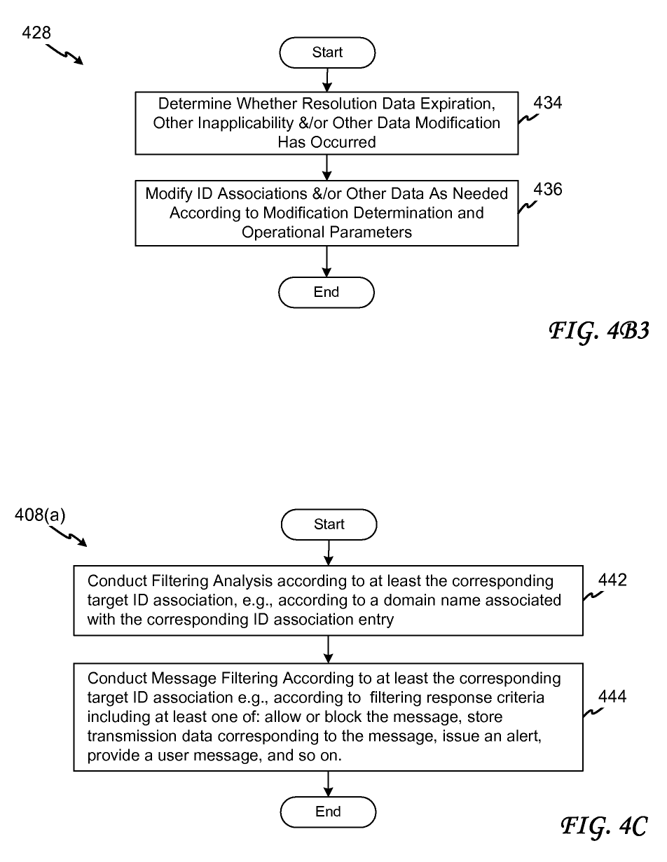

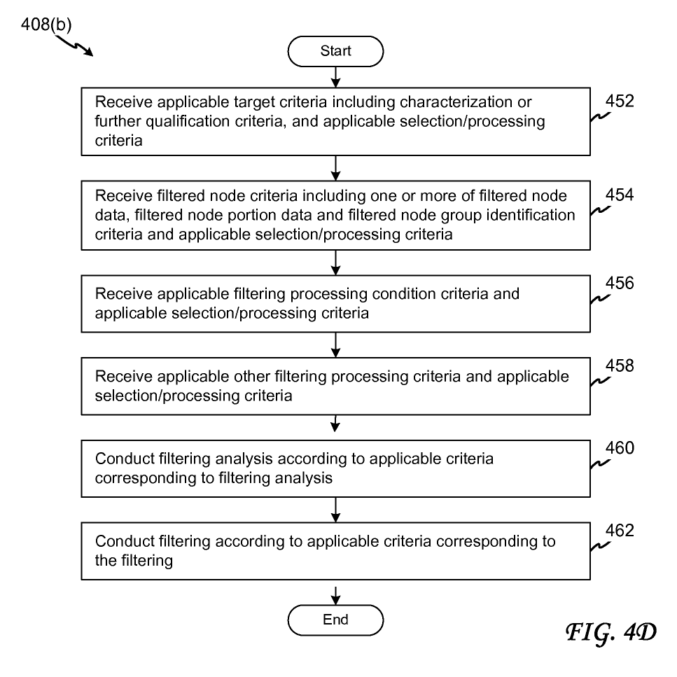

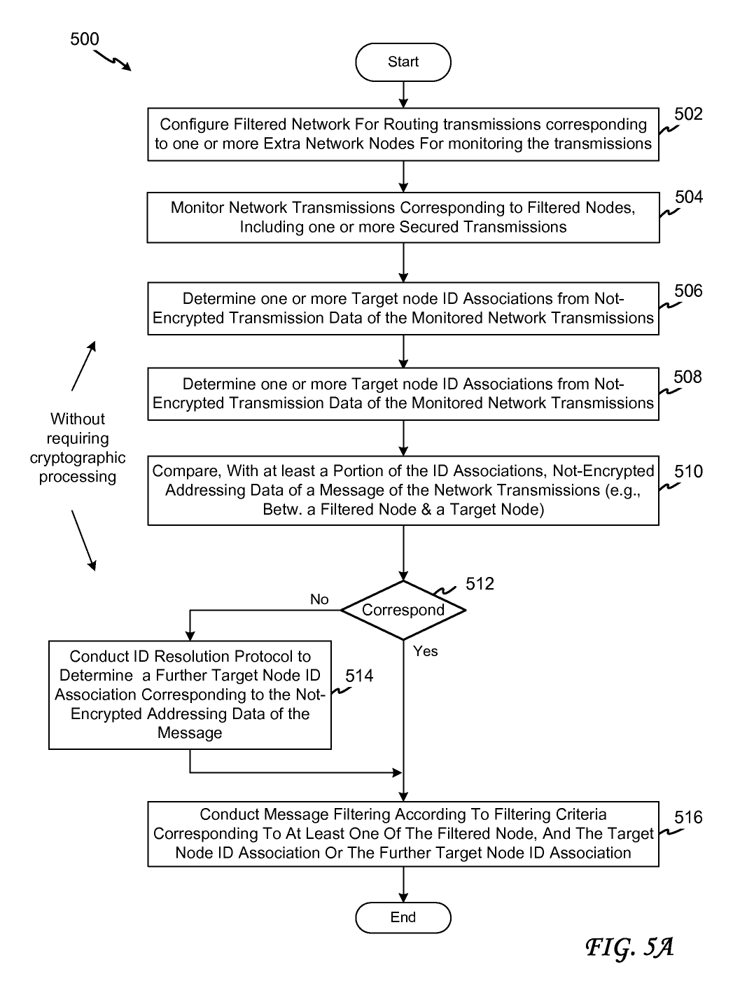

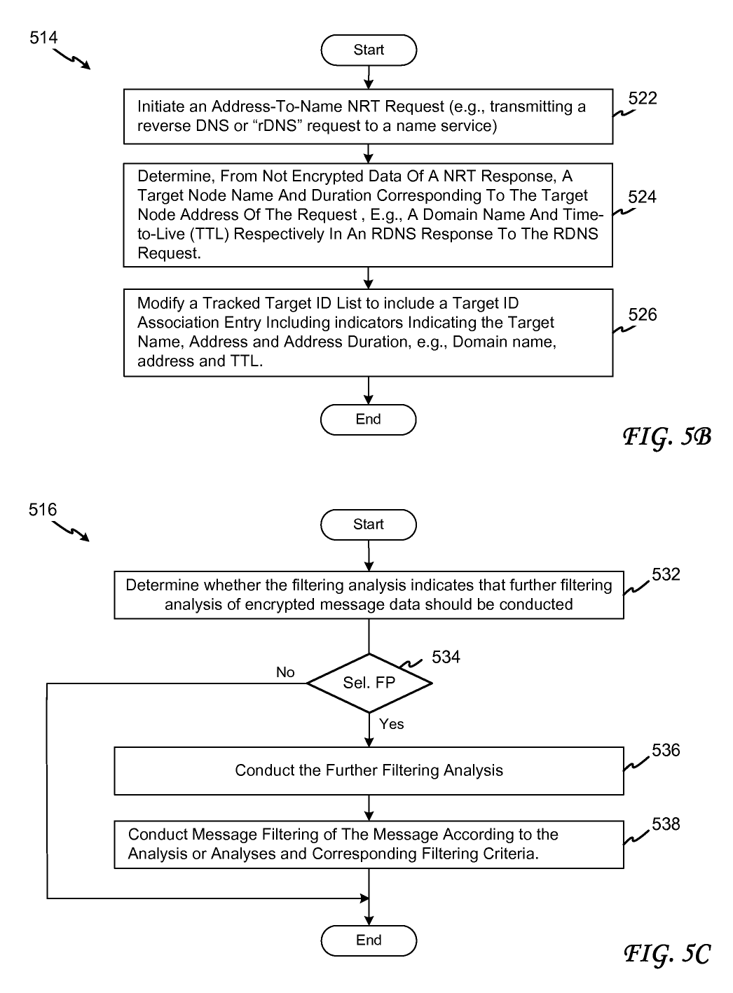

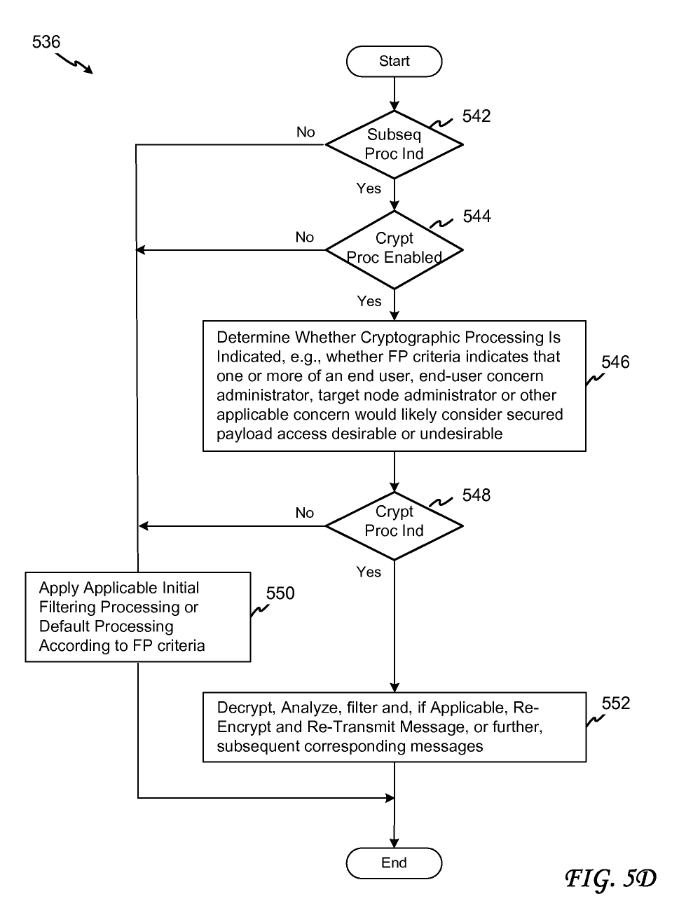

Turning now to FIGS. 4a through 5d, there are seen network filtering method 400a examples according to the invention that provide for filtering secured or further unsecured message transmissions corresponding to filtered nodes, without requiring cryptographic processing. Such methods may, for example, be conducted by one or more of the above discussed network filtering system examples or otherwise in accordance with the requirements of a particular implementation. As with the above discussed network filtering systems, method 400a may be utilized alone or in conjunction with other network or other filtering or other processing that may otherwise be conducted, and may but need not receive processing indicators indicating such processing. FIG. 4a illustrates a broad network filtering method embodiment while FIGS. 4b through 4d illustrate more detailed method embodiments corresponding to portions of method 400a. FIGS. 5a through 5d further illustrate another network filtering method embodiment that may also be used in conjunction with extra-filtered network or other filtered or other nodes.

For clarity sake, the discussion will continue to presume that SHTTP or further HTTP, as well as DNS and TCP/IP protocols are utilized in conjunction with a target network including the Internet, and that the method is implemented by at least one network filter, so that aspects of the invention may be better understood. It should be appreciated, however, that other protocols, components or combinations thereof may also be used in accordance with the requirements of a particular implementation.

Method 400a of FIG. 4a includes, in block 402, monitoring network transmissions corresponding to associated filtered nodes, the network transmissions including one or more secured transmissions. The monitored network transmissions may, for example, include one or more protocol transmissions and one or more message transmissions corresponding to the filtered nodes, or in other embodiments, may also include protocol/message transmissions corresponding to other filterable nodes or other network nodes as well. Such monitoring may, for example, include physically or virtually configuring the network such that a corresponding network filter receives transmissions corresponding to the filtered nodes or otherwise receiving the filtered node transmissions via a network, as was already discussed. (Conventional or other specific transmission monitoring techniques may also be used in accordance with the requirements of a particular implementation.)

Block 404 includes determining one or more target node identification associations (“target ID associations”) corresponding to not-encrypted transmission data of the monitored network transmissions. As shown in the FIG. 4b1 example, block 404 of FIG. 4a may include determining that the network transmissions include a name resolution transmission or “NRT” request (e.g., DNS request) corresponding to one of the filtered node (block 422) and determining a target node name as a name portion of the NRT request or a corresponding NRT response (e.g., DNS response) in block 424. Block 404 (FIG. 4a) may also include determining a target node address and duration corresponding to address and duration portions of the NRT response in block 426 of FIG. 4b1 and modifying a tracked target ID list (e.g., the above ID association cache or other storage) to include a (current) target ID association entry including indicators indicating the target node name, address and address duration in block 428.

As was already discussed, DNS and other at least conventional secured and unsecured NRT interaction includes a request and corresponding response, the headers and payloads of which are not encrypted. Transmissions may, for example, be determined to include a DNS request or response corresponding to a filtered node by identifying the well established request and response formats or using other suitable techniques, and by determining that the source and destination addresses included in the respective request and response headers correspond to a filtered node. Such correspondence may, for example, be determined by comparing the source and destination addresses with a stored filtered node identification list or other stored set that includes respective filtered node IP addresses indicating associated filtered nodes. Such correspondence may also include, in other embodiments, monitoring all node transmissions as corresponding to filtered nodes, and so on or some combination, e.g., as was already discussed. The target node name, address and duration (e.g., domain name, IP address and TTL) may be similarly determined by identifying such data that is included in a DNS or other NRT response payload, and may, for example, be associated with each other and stored, or further, with a filtered node or with a filtered node group, condition, target or other information or one or more portions or combinations thereof, e.g., as was already discussed.

Those skilled in the art will further appreciate that an NRT response or reverse NRT response may also include a target host name or address, or other information that may or may not be utilized in conjunction with a particular filtering processing implementation. Block 432 of FIG. 4b2, for example, illustrates how superfluous such additional information may be discarded, while additional such information that may be used in conjunction with a filtering processing implementation may be separately stored or further associated with the ID association entry or other stored information. Similarly, information stored in the tracked target ID list may include expired, already utilized or other superfluous information that may no longer be utilized in conjunction with filtering processing. As shown in FIG. 4b3, such superfluous information may, for example, be determined in conjunction with storing a target ID association entry (block 434), and may be replaced by corresponding new ID association information (e.g., a new entry) or simply discarded (block 436). In other embodiments, list maintenance operation may also be conducted independently.

Returning to FIG. 4a, block 405 includes determining that the monitored network transmissions include a message transmission (“message”) corresponding to a filtered node (i.e. an associated filtered node). Such determining may, for example, include determining that a message header of the message, which is not encrypted in at least conventional secured and unsecured protocols, includes a source address that block 405 determines corresponds to the filtered node, and a destination address. Such determining may, for example, be conducted according to the transmission format, or otherwise in accordance with the requirements of a particular implementation. Correspondence with an associated filtered node may, for example, be determined by comparing the source IP address with the statically or dynamically determined filtered node set. However, other methods or some combination may also be utilized. (E.g., see above.)

Block 406 of FIG. 4a includes comparing, with at least a portion of the target ID associations, the non-encrypted addressing data of the message. The particular comparing may differ in accordance with various association and comparing embodiments. As discussed, for example, various filtered node-specific embodiments provide for determining a correspondence of target identification associations with a particular filtered node whose transmissions provided the target identification data (“current filtered node”) or for comparing message addressing data with only target identification associations that correspond with the current filtered node. Other general applicability embodiments more broadly provide for a correspondence of target identification associations with all filtered, filterable or other nodes, or for comparing message addressing data with one or more of these. Still further node specific or general applicability embodiments may also provide for conducting the associating or comparing in accordance with nodes, node groups or portions thereof, or according to conditions or other network filtering criteria. The comparing may therefore be conducted by comparing the addressing data with associated or “corresponding” target identification associations using any suitable comparing technique or techniques in accordance with a particular implementation.

Block 408 of FIG. 4a includes conducting message filtering that corresponds with one or more of the target node ID associations and the filtered node. As discussed earlier with regard to network filtering systems, various network filtering method embodiments may also provide a correspondence of filtering criteria with target node information, filtered node information or both. FIG. 4c, for example, shows how message filtering may include filtering analysis (block 442) and filtering response processing or “filtering” (block 444), one or both of which may be conducted according to at least the corresponding target ID association of block 406 of FIG. 4a, or further, to filtered node or other information. Broadly stated, filtering analysis provides for determining whether filtering should be applied, while filtering provides for determining a particular filtering response that may be applied to the current or subsequent corresponding messages, or for conducting a filtering response.

Either or both of filtering analysis and filtering may also be conducted according to criteria or “policies” that may further include the same or different policies. The results of filtering analysis or filtering may also be applied to a current message, or further, to one or more subsequent messages between the current filtered node and a target node or between one or more other nodes and a current-message target node or “current target node”. (It will be appreciated that such analysis or filtering type filtering processing may also be applicable to broadcasting, multicasting or other one-to-many or many-to-one messaging in embodiments supporting filtering processing of such messaging.)

FIG. 4d, for example, illustrates one embodiment of policy-based filtering processing. As shown in FIG. 4d, a wide variety of criteria or “policy” types may be utilized. Policy types for purposes of the present example include target characterizations or further qualifications (block 452), filtered node, group or portion criteria (block 454), conditions (block 456) and other criteria (458), the same or different ones of which may be utilized in conjunction with conducting filtering analysis (block 450) or filtering (block 452). Each of these policy types may, for example, correspond with policy types already discussed in conjunction with network filtering systems.

FIG. 4d also illustrates how each policy type may be further divided into descriptive criteria and corresponding policy selection and processing criteria. Descriptive criteria includes characterizations that may be determined by a filter manufacturer, end user concern, node provider, dynamic network filter operation, and so on or some combination (referred to hereinafter as a “characterizer”). The characterizations may characterize or qualify a characterization of a target node, filtered node, conditions, data types, and so on or some portion or combination thereof, and may be received (e.g., and stored). Selection criteria further include characterization or qualification indicators indicating those factors for which administrative, other end user, other personnel or some combination (referred to hereinafter as a “selector”) may desire filtering processing to be conducted. Finally, processing criteria may include criteria according to which filtering processing (i.e., filtering analysis or filtering) may be conducted. While typically provided by a network filter manufacturer, various embodiments may also provide for enabling administration or other end user personnel or others to determine processing criteria as well. (The form or execution of such criteria may vary in accordance with the requirements of a particular implementation.)

Thus, for example, block 452 may provide for receiving characterization or qualifying criteria corresponding to ones of various potential target nodes (i.e. or groups of such nodes). Such characterization or qualifying criteria may describe such nodes as providing personal/business related, adult, banking, high/low bandwidth, video or other content, media types or other product or services, or further provide qualification of one or more of these. Block 452 may also provide for receiving selector selection criteria that, if applicable (i.e., or inapplicable) to a current transmission, should cause filtering processing to be conducted in conjunction with the current or subsequent transmissions as were discussed earlier. Such selections criteria may, for example, merely include target nodes that may provide adult material. Block 452 may also provide for receiving filtering analysis or filtering parameters to be applied in conjunction with such characterizations, qualifications or selections. (For clarity sake, let us presume that the characterization, qualification, selection and processing criteria of 454 through 458 are inapplicable in a particular implementation.) If a current message transfer is initiated with a target node and filtering analysis block 460 determines that descriptive data associated with the target node indicates that target node provides adult content, then because the selection data also includes adult content, block 450 indicates that filtering should be conducted; block 462 further determines a type/extent of filtering (e.g., a corresponding filtering response) and initiates such filtering. The filtering analysis or filtering of the filtering processing (blocks 460-462) may further conduct filtering more generally according to such characterization and selection correspondence, or more specifically according to the target node description. Other criteria of blocks 454 through 458 may also be similarly utilized either alone or in combination (e.g., a correspondence of any one characterization and selection or some combination of characterizations and selections causing more general or more specific filtering analysis or filtering.

Thus an embodiment of the present invention comprises the following steps:
monitoring a plurality of network transmissions corresponding to filtered nodes including at least one secured transmission 402;
determining at least one target node identity associations from not encrypted transmission data of the monitored network transmissions 404;
determining that the monitored network transmissions include a message transmission corresponding to a filtered node 405;
comparing addressing data of the message with at least one of the target node identity associations 406; and
conducting message filtering if addressing data of the message corresponds with a target node identity association 408.

In the present embodiment, determining at least one target node identity associations from not encrypted transmission data of the monitored network transmissions 404 comprises
determining that the network transmissions include a name resolution transmission (NRT) request corresponding to a filtered node 422;
determining a target node name as a name portion of the NRT request or a corresponding non-encrypted NRT response 424;
determining a target node address and duration corresponding to address and duration portions of the NRT response 426; and
modifying a tracked target ID list to include a target ID association entry including indicators indicating the target name, address, and address duration 428.

In the present embodiment, determining a target node address and duration corresponding to address and duration portions of the NRT response 426 further comprises discarding or separately storing selected resolution data 432.

In the present embodiment, modifying a tracked target ID list to include a target ID association entry including indicators indicating the target name, address, and address duration 428 further comprises
determining whether resolution data expiration, other inapplicability, and/or other data modification has occurred 434 and
modifying ID associations and/or other data as needed according to modification determination and operational parameters 436.

In the present embodiment, conducting message filtering if addressing data of the message corresponds with a target node identity association 408 comprises
conducting filtering analysis according to at least the corresponding target ID association 442, and
conducting message filtering according to at least the corresponding target ID association comprising at least one of allowing or blocking the message,
storing transmission data corresponding to the message,
issuing an alert, and
providing a user message 444.

In the present embodiment, conducting message filtering if addressing data of the message corresponds with a target node identity association 408 further comprises
receiving applicable target criteria including characterization or further qualification criteria and applicable selection/processing criteria 452,
receiving filtered node criteria including at least one of filtered node data, filtered node portion data, and filtered node group identification criteria and applicable selection/processing criteria 454,
receiving applicable filtering processing condition criteria and applicable selection/processing criteria 456,
receiving applicable other filtering processing criteria and applicable selection/processing criteria 458,
conducting filtering analysis according to applicable criteria corresponding to filtering analysis 460, and
conducting filtering according to applicable criteria corresponding to the filtering 462.

FIG. 5a illustrates a further example of a network filtering method according to the invention. In addition to demonstrating usability in conjunction with a variety of network systems, FIG. 5a also demonstrates examples of invention aspects in a more understandable manner that may then be more readily applied to other implementations.

Method 500 of FIG. 5a more specifically illustrates a network filtering embodiment that is useable in conjunction with network configurations that may include one or more virtual private network (“VPN”) or other extra-filtered network coupled (hereinafter, “extra network”) filtered nodes. While it will become apparent that method 500 may also be used in conjunction with intra-filtered network (hereinafter, “intra network”) filtered nodes or other filterable or other nodes, the discussion will focus on extra network filtered nodes coupled via a VPN. As with method 400, method 500 may also be conducted without requiring cryptographic processing of at least filtered node message transmissions.

It will be appreciated, for example, that due to its extra-network coupling, a need for virtually or physically routing of VPN coupled filtered node (“filtered VPN node”) transmissions such that they may be monitored (block 502) is more apparent than with the method 400 example of FIG. 4. Blocks 504 through 510, however, correspond with blocks 402 through 406 of method 400 and may, for example, be conducted in the same manner as with blocks 402 through 406.

It should also be more apparent respecting a filtered extra-network node that a possibility exists for the filtered extra-network node to conduct a name service protocol interaction that is nevertheless not monitored or otherwise processed by a network filter. As was discussed regarding network filtering systems, such protocol monitoring failure may, for example, arise due to prior buffering by a filtered extra-network node client or for other reasons (e.g., see above). However, such a state may also arise respecting a filtered intra-network or other filterable node. In such cases, the addressing data may not correspond with at least a portion of the ID associations in block 512, and if not, then block 514 provides for conducting an ID resolution protocol (e.g., “rDNS”) to determine a further target node association corresponding to the not-encrypted addressing data of the message. Block 516 is therefore modified from block 408 of method 400 (FIG. 4a) such that message filtering may be conducted according to filtering criteria corresponding to at least one of the filtered node and the target node ID association (e.g., if a correspondence is found in block 512) or the further target node ID association (e.g., if a correspondence is not found in block 512).

Exemplary method 504 of FIG. 5b illustrates in greater detail how the conducting of an ID resolution protocol may include initiating an address-to-name NRT request (e.g., transmitting a reverse DNS request) in block 522, and determining, from received not encrypted payload data of the NRT response data, a target node name and duration corresponding to the target node address of the NRT request (e.g., from payload data of a received rDNS response) in block 524. Method 504 of FIG. 5b also includes modifying a tracked target id list to include a target id association entry including indicators indicating the target name, address and address duration, e.g., domain name, address and time to live or “TTL” in block 526.

It should further be more apparent that, while applicable to intra-network nodes, configuring a filtered network for enabling a VPN (or other extra-network) coupled node will likely provide filtered node portion information, such as type or types of user device(s), client or clients, and so on, and that such information may be used to generate filtering processing criteria that may received, for example, in accordance with method 408(b) of FIG. 4d. The likelihood that location, VPN-versus-local coupling, other condition or other information may be available in conjunction with a filtered VPN node and that such information may used to generate such received filtering processing criteria should also be apparent, although such information is also likely available for local filtered nodes as well. For example, a filtered VPN node that is coupled through a filtered network of a business concern (e.g., to the Internet) is likely coupled from a remote location. Similarly, at least the intended location of filtered nodes is also likely to become known at least during user device configuration for coupling to a filtered network (e.g., intra-network versus home or mobile device), as may be working hours of a user, user identity or group, and so on (e.g., see above). Current time, more specific location, other conditions or other information may also be easily determined using conventional computing, networking or other techniques (e.g., see above) and these too may be utilized in configuring filtering criteria received and utilized according to method 408(b), as may business-related or otherwise specifiable target nodes, likely or actual media type, and so on, among other combinable examples.

Turning now to FIGS. 5c and 5d, potential filtering analysis and filtering of methods 400 and 500 (FIGS. 4a and 5a) may extend beyond the initial filtering processing, and may include further initial or subsequent filtering processing. It will be appreciated, for example, that initial filtering processing such as that already discussed may employ characterizations or qualifications or become subject to conditions that may yet result in disallowing messages that may in fact be considered allowable and desirably allowed or allowing messages that may in fact be considered not-allowable and for which filtering processing may desirably cause one or more of blocking or other filtering responses. Unsecured messages, for example may be more desirably subject to further filtering in particularly selected cases in which analysis of payload information may provide for filtering analysis or response that more likely corresponds with filtering that end user concern may desire. Secured or unsecured messages may be directed at a target node that provides or is characterized as providing both allowable and not-allowable resource content or media, business and personal resources, and so on. Initial filtering processing of a target node for which a domain name ultimately remains unknown may also undesirably result in application of an undesirable default filtering response (e.g., see above), among other examples.

As shown in method 516 of FIG. 5c filtering processing may therefore include determining whether the filtering analysis indicates that further filtering analysis of encrypted message data should be conducted (block 532). If such determining indicates that further filtering analysis should be conducted in block 534, then the further filtering analysis of is conducted in block 534 and filtering is conducted according to the initial, further or both analyses and corresponding filtering criteria in block 538. If instead further filtering analysis is not warranted in block 534, then method 516 ends.

FIG. 5d further illustrates an example of a method according to which filtering analysis 536 of FIG. 5c may further utilize selective cryptographic processing of messages. As shown in FIG. 5d, if subsequent filtering processing is indicated in block 542 (e.g., see above) and cryptographic processing is enabled and may be generally conducted in block 544, then block 546 includes determining whether cryptographic processing is indicated; the method otherwise continues with block 550. That cryptographic processing is or is not indicated may, for example, include, in block 546, determining whether the filtering processing criteria indicates that a concern of interest would likely considered secured payload access desirable (i.e., or undesirable). A concern of interest may, for example, include one or more of an end user, end user concern administrator, target node administrator, legal authority or other applicable concern. If cryptographic processing is further indicated in block 548, then the method includes conducting filtering processing of the current, or further, subsequent corresponding messages in block 552 (e.g., decrypting, analyzing, filtering and, if applicable re-transmitting the current message, or further, subsequent corresponding messages). If instead cryptographic processing is not indicated in block 548, then initial filtering processing or default filtering processing is applied, as according to applicable filtering processing criteria, in block 550.

Another embodiment of the present invention comprises: the following steps:
monitoring a plurality of network transmissions corresponding to filtered nodes including at least one secured transmission 402;
determining at least one target node identity associations from not encrypted transmission data of the monitored network transmissions 404;
determining that the monitored network transmissions include a message transmission corresponding to a filtered node 405;
comparing addressing data of the message with at least one of the target node identity associations 406; and
conducting message filtering if addressing data of the message corresponds with a target node identity association 408.

In another embodiment determining at least one target node identity associations from not encrypted transmission data of the monitored network transmissions 404 comprises
determining that the network transmissions include a name resolution transmission (NRT) request corresponding to a filtered node 422;
determining a target node name as a name portion of the NRT request or a corresponding non-encrypted NRT response 424;
determining a target node address and duration corresponding to address and duration portions of the NRT response 426; and
modifying a tracked target ID list to include a target ID association entry including indicators indicating the target name, address, and address duration 428.

In another embodiment, determining a target node address and duration corresponding to address and duration portions of the NRT response 426 further comprises discarding or separately storing selected resolution data 432.

In another embodiment, modifying a tracked target ID list to include a target ID association entry including indicators indicating the target name, address, and address duration 428 further comprises
determining whether resolution data expiration, other inapplicability, and/or other data modification has occurred 434 and
modifying ID associations and/or other data as needed according to modification determination and operational parameters 436.

In another embodiment, conducting message filtering if addressing data of the message corresponds with a target node identity association 408 comprises
conducting filtering analysis according to at least the corresponding target ID association 442, and
conducting message filtering according to at least the corresponding target ID association comprising at least one of allowing or blocking the message, storing transmission data corresponding to the message, issuing an alert, and providing a user message 444.

In another embodiment, conducting message filtering if addressing data of the message corresponds with a target node identity association 408 further comprises
receiving applicable target criteria including characterization or further qualification criteria and applicable selection/processing criteria 452,
receiving filtered node criteria including at least one of filtered node data, filtered node portion data, and filtered node group identification criteria and applicable selection/processing criteria 454,
receiving applicable filtering processing condition criteria and applicable selection/processing criteria 456,
receiving applicable other filtering processing criteria and applicable selection/processing criteria 458,
conducting filtering analysis according to applicable criteria corresponding to filtering analysis 460, and
conducting filtering according to applicable criteria corresponding to the filtering 462.

In another embodiment, the invention further includes:
configuring a filtered network for routing transmissions corresponding to at least one extra network nodes for monitoring the transmissions 502.

In another embodiment, the invention further includes:
conducting ID resolution protocol to determine a further target node ID association corresponding to the not-encrypted addressing data of the message 514.

In another embodiment, conducting ID resolution protocol to determine a further target node ID association corresponding to the not-encrypted addressing data of the message 514 comprises the steps following:
initiating an address to name NRT request to a name service 522,
determining from not-encrypted data of an NRT response a target node name and duration corresponding to the target node address of the request 524, and
modifying a tracked target ID list to include a target ID association entry including indicators indicating the target name, address, and address duration 526.

In another embodiment, the invention further includes
conducting message filtering according to filtering criteria corresponding to at least one of the filtered node and the target node ID association or the further target node ID association 516.

In another embodiment, conducting message filtering according to filtering criteria corresponding to at least one of the filtered node and the target node ID association or the further target node ID association 516 comprises the steps following:
determining whether the filtering analysis indicates that further filtering analysis of encrypted message data should be conducted 532,
conducting the further filtering analysis 536, and
conducting message filtering of the message according to the analysis or analyses and corresponding filtering criteria 538.

### CONCLUSION

A network filtering system and method without requiring cryptographic processing of secure message transmissions is disclosed. The method provides for determining target node ID associations corresponding to domain names of filtered node DNS requests and corresponding network address and address duration data determined according to a corresponding DNS responses. The method also provides for comparing a destination address of a current message transmission corresponding to a filtered node with the determined target node ID associations, and conducting filtering processing of the current message transmission.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention.

What is claimed is:

1. A method comprising the following steps:
monitoring a plurality of network transmissions corresponding to filtered nodes including at least one secured transmission 402;
determining at least one target node identity associations from not encrypted transmission data of the monitored network transmissions 404;
determining that the monitored network transmissions include a message transmission corresponding to a filtered node 405;
comparing addressing data of the message with at least one of the target node identity associations 406; and
conducting message filtering if addressing data of the message corresponds with a target node identity association 408.

2. The method of claim one wherein determining at least one target node identity associations from not encrypted transmission data of the monitored network transmissions 404 comprises
determining that the network transmissions include a name resolution transmission (NRT) request corresponding to a filtered node 422;
determining a target node name as a name portion of the NRT request or a corresponding non-encrypted NRT response 424;
determining a target node address and duration corresponding to address and duration portions of the NRT response 426; and
modifying a tracked target ID list to include a target ID association entry including indicators indicating the target name, address, and address duration 428.

3. The method of claim 2 wherein determining a target node address and duration corresponding to address and duration portions of the NRT response 426 further comprises discarding or separately storing selected resolution data 432.

4. The method of claim 2 wherein modifying a tracked target ID list to include a target ID association entry including indicators indicating the target name, address, and address duration 428 further comprises determining whether resolution data expiration, other inapplicability, and/or other data modification has occurred 434 and modifying ID associations and/or other data as needed according to modification determination and operational parameters 436.

5. The method of claim one wherein conducting message filtering if addressing data of the message corresponds with a target node identity association 408 comprises conducting filtering analysis according to at least the corresponding target ID association 442, and
conducting message filtering according to at least the corresponding target ID association comprising at least one of allowing or blocking the message, storing transmission data corresponding to the message, issuing an alert, and providing a user message 444.

6. The method of claim 5 wherein conducting message filtering if addressing data of the message corresponds with a target node identity association 408 further comprises receiving applicable target criteria including characterization or further qualification criteria and applicable selection/processing criteria 452,
receiving filtered node criteria including at least one of filtered node data, filtered node portion data, and filtered node group identification criteria and applicable selection/processing criteria 454,
receiving applicable filtering processing condition criteria and applicable selection/processing criteria 456,
receiving applicable other filtering processing criteria and applicable selection/processing criteria 458,
conducting filtering analysis according to applicable criteria corresponding to filtering analysis 460, and
conducting filtering according to applicable criteria corresponding to the filtering 462.

7. The method of claim one further comprising the step following:
configuring a filtered network for routing transmissions corresponding to at least one extra network nodes for monitoring the transmissions 502.

8. The method of claim one further comprising the step following:
conducting ID resolution protocol to determine a further target node ID association corresponding to the not-encrypted addressing data of the message 514.

9. The method of claim 8 wherein conducting ID resolution protocol to determine a further target node ID association corresponding to the not-encrypted addressing data of the message 514 comprises the steps following:
initiating an address to name NRT request to a name service 522,
determining from not-encrypted data of an NRT response a target node name and duration corresponding to the target node address of the request 524,
and
modifying a tracked target ID list to include a target ID association entry including indicators indicating the target name, address, and address duration 526.

10. The method of claim one further comprising the step following:
conducting message filtering according to filtering criteria corresponding to at least one of the filtered node and the target node ID association or the further target node ID association 516.

11. The method of claim wherein conducting message filtering according to filtering criteria corresponding to at least one of the filtered node and the target node ID association or the further target node ID association 516 comprises the steps following:
determining whether the filtering analysis indicates that further filtering analysis of encrypted message data should be conducted 532,
conducting the further filtering analysis 536, and
conducting message filtering of the message according to the analysis or analyses and corresponding filtering criteria 538.
